(19) United States
(12) Patent Application Publication
(10) Pub. No.: US 2026/0097855 A1
(43) Pub. Date: Apr. 9, 2026

(54) Frangible Fitting with Fail Safe Straps

(71) Applicant: The Boeing Company, Arlington, VA (US)

(72) Inventors: Reed Daniel Wilson, Kirkland, WA (US); Kyle David Stevens, Mill Creek, WA (US); Ryan James Clabots, Mukilteo, WA (US); Donald Thomas Powell, Everett, WA (US); Adrian Stanescu, Maple Valley, WA (US)

(21) Appl. No.: 19/280,615

(22) Filed: Jul. 25, 2025

Related U.S. Application Data
(60) Provisional application No. 63/704,162, filed on Oct. 7, 2024.

(51) Int. Cl. B64D 29/06

(52) U.S. Cl. CPC B64D 29/06

(57) ABSTRACT

A mount to connect a fan cowl support beam to an engine fan case of an aircraft. The mount has a primary load path component and a secondary load path component. The primary load path component is configured to fuse upon application of a force from the fan case that is above a predetermined threshold. The secondary load path component is configured to remain functional upon application of the force above the predetermined threshold to maintain the fan cowl support beam connected to the fan case.

### RELATED APPLICATIONS

This application claims the benefit of U.S. Provisional Application No. 63/704,162, filed on Oct. 7, 2024, which is hereby incorporated by reference in its entirety.

### TECHNOLOGICAL FIELD

The present disclosure relates generally to the field of mounts for connecting first and second members and, more specifically, to mounts that include a primary load path component and a secondary load path component.

### BACKGROUND

A jet engine of an aircraft includes a nacelle that extends around the exterior of the engine. The nacelle forms an aerodynamic housing for the engine. The nacelle is often divided into multiple sections. Examples of sections include one or more cowls (e.g., inlet cowl, fan cowl) and a thrust reverser. The nacelle includes an aerodynamic shape due to its exposed position on the exterior of the aircraft, such as on the wing of the aircraft. The nacelle is also shaped to be aerodynamically efficient.

The nacelle is designed to withstand a fan blade off (FBO) event that involves a fan of the engine. During an FBO event, a blade of the fan breaks off or is otherwise released from the fan. The rotational speed of the fan causes the released blade to be propelled radially outward away from the engine and into contact with an engine fan case. The released blade imparts a large amount of energy to the engine fan case which is turn is transferred to other parts of the aircraft such as the fan cowl support beam, fan cowl, and other nacelle components.

Mounts connect a fan cowl support beam to the fan case. The mounts are designed to withstand an FBO event and to maintain its connection to the fan case. To account for an FBO event, existing solutions include increasing the size and strength of the mounts to handle the increased loads. Making the mounts larger and stronger results in a stiffer design which tends to cause the mounts to pick up additional load. Further, the larger designs are not efficient as they add weight to the aircraft. Thus, a mount design is needed that maintains the connection between the fan cowl support beam and the fan case during an FBO event without greatly decreasing the aircraft efficiency.

### SUMMARY

One aspect is directed to a mount to connect a fan cowl support beam to a fan case of an aircraft. The mount comprises a primary load path component configured to be connected to the fan cowl support beam and to the fan case, and a secondary load path component comprising a flexible body comprising a first end configured to be connected to the fan cowl support beam and a second end configured to be connected to the fan case. Wherein the primary load path component is configured to fuse upon application of a force from the fan case that is above a predetermined threshold. Wherein the secondary load path component is configured to remain functional upon application of the force above the predetermined threshold to maintain the fan cowl support beam connected to the fan case.

In another aspect, the secondary load path component comprises an interior space formed between the first end and the second end and the primary load path component is positioned within the interior space.

In another aspect, the primary load path component comprises a beam comprising an elongated shape with a first end connected to the first end of the secondary load path component and a second end mounted connected to the second end of the secondary load path component.

In another aspect, a fusing feature is positioned along the beam between the first end and the second end of the beam with the fusing feature comprising a smaller sectional size than a remainder of the beam.

In another aspect, the primary load path component comprises spacers that extend between the first end and the second end of the secondary load path component with the spacers being spaced apart within an interior space of the secondary load path component.

In another aspect, the primary load path component comprises a support section and a fusing feature configured to fuse prior to the support section when the force applied by the fan case is above the predetermined threshold.

In another aspect, the primary load path component comprises a beam with upper and lower flanges and extensions that extend outward from the flanges with the primary load component further comprising a fuse pin that connects together two or more of the extensions.

In another aspect, the primary load path component and the secondary load path component are separate members that are connected together.

In another aspect, the secondary load path component comprises a pair of bent flanges that comprise arms that are connected together at an elbow with the arms configured to move relative to each other and be positioned at different angular positions.

One aspect is directed to a mount to connect a fan cowl support beam to a fan case of an aircraft. The mount comprises a primary load path component comprising: a beam comprising an elongated shape with a first end configured to be connected to the fan cowl support beam and a second end configured to be connected to the fan case; and a fusing feature positioned along the beam between the first end and the second end, the fusing feature comprising a smaller sectional size than a remainder of the beam. A secondary load path component comprises a flexible body comprising a first end configured to be connected to the fan cowl support beam and a second end configured to be connected to the fan case. Wherein the primary load path component is configured to fuse upon application of a force from the engine that is above a predetermined threshold. Wherein the secondary load path component is configured to remain functional upon application of the force above the predetermined threshold.

In another aspect, the primary load path component is mounted within an interior space of the flexible body of the secondary load path component.

In another aspect, the secondary load path component comprises a plurality of flexible bent flanges with the primary load path component positioned between two of the plurality of flexible bent flanges.

In another aspect, the fusing feature comprises a thickness that is less than a remainder of the beam.

In another aspect, the primary load path component comprises a beam with extensions that extend outward from opposing flanges and wherein the fusing feature comprises a fuse pin that connects together a plurality of the extensions.

In another aspect, the primary load path component comprises a plurality of spacers each with an elongated shape and having a first end configured to be connected to the fan cowl support beam and a second end configured to be connected to the fan case.

One aspect is directed to a method of mounting a fan cowl support beam to a fan case of an aircraft. The method comprises: supporting the fan cowl support beam on the fan case during flight with both a primary load path component and a secondary load path component; during the flight, applying an excessive force from the fan case to both the primary load path component and the secondary load path component; fusing the primary load path component and flexing the secondary load path component while applying the excessive force; and supporting the fan cowl support beam relative to the fan case with just the secondary load path component after fusing the primary load path component.

In another aspect, the method further comprises transferring forces on the fan case to the fan cowl support beam through the primary load path component and the secondary load path component prior to applying the excessive force.

In another aspect, the method further comprises fusing the primary load path component at a fusing feature.

In another aspect, the method further comprises: bending the secondary load path component to a first angular position while applying the excessive force; and reducing an amount of force applied to the fan cowl support beam through the fan case and bending the secondary load path component a lesser amount to a second angular position.

In another aspect, the method further comprises applying the excessive load during a fan blade out event during the flight.

One example is directed to a mount to connect a fan cowl support beam to a fan case of an engine. The mount comprises a primary load path component connected to each of the fan cowl support beam and the fan case with the primary load path component configured to connect the fan cowl support beam to the fan case when a force applied by the engine is below a predetermined threshold. A secondary load path component is connected to each of the fan cowl support beam and the fan case with the secondary load path component configured to connect the fan cowl support beam to the fan case when the force applied by the engine is above the predetermined threshold.

In another example, the primary load path component comprises: a support section; and a fusing feature configured to fuse prior to the support section when the force applied by the fan case is above the predetermined threshold.

In another example, the fusing feature is positioned at an intermediate location along a height of the primary load path component.

In another example, the fusing feature comprises a smaller thickness than the support section.

In another example, the primary load path component comprises multiple members that are spaced apart.

In another example, the multiple members comprise a common shape and size.

In another example, the primary load path component and the secondary load path component are separate members that are connected together.

In another example, the secondary load path component comprises a pair of bent flanges that comprise arms that are connected together at an elbow with the arms configured to move relative to each other and be positioned at different angular positions.

In another example, a fitting is connected to one of the primary load path component and the secondary load path component with the fitting configured to connect the fan cowl support beam to the fan case.

In another example, the mount includes multiple primary load path components and multiple secondary load path components.

One example is directed to a mount to connect a fan cowl support beam to a fan case. The mount comprises a secondary load path component comprising a flexible body comprising a first end configured to be connected to the fan case and a second end configured to be connected to the fan cowl support beam with the secondary load path component further comprising an interior space formed between the first end and the second end. A primary load path component is positioned within the interior space of the secondary load path component. The primary load path component is configured to fuse upon application of a force from the fan case that is above a predetermined threshold. The secondary load path component is configured to remain functional upon application of the force above the predetermined threshold.

In another example, the primary load path component comprises a beam comprising an elongated shape with a first end connected to the first end of the secondary load path component and a second end mounted connected to the second end of the secondary load path component.

In another example, a fusing feature is positioned along the beam between the first end and the second end with the fusing feature comprising a smaller sectional size than a remainder of the beam.

In another example, the primary load path component comprises spacers that extend between the first end and the second end of the secondary load path component with the spacers being spaced apart within the interior space.

In another example, the spacers comprise a cylindrical shape.

One example is directed to a mount to connect a fan cowl support beam to a fan case. The mount comprises a primary load path component comprising a beam comprising an elongated shape with a first end configured to be connected to the fan case and a second end configured to be connected to the fan cowl support beam, and a fusing feature positioned along the beam between the first end and the second end with the fusing feature comprising a smaller sectional size than a remainder of the beam. A secondary load path component comprises a flexible body component comprising a first end configured to be connected to the fan case and a second end configured to be connected to the fan cowl support beam. The primary load path component is configured to fuse upon application of a force from the fan case that is above a predetermined threshold. The secondary load path component is configured to remain functional upon application of the force above the predetermined threshold.

In another example, the primary load path component further comprises a first flange mounted to the first end of the beam and a second flange mounted to the second end of the beam.

In another example, the primary load path component is mounted within an interior space of the secondary load path component.

In another example, the secondary load path component comprises a first flexible bent flange and a second flexible bent flange with the primary load path component positioned between the first flexible bent flange and the second flexible bent flange.

In another example, the fusing feature comprises a thickness that is less than a remainder of the beam.

In another example, the fusing feature comprises one or more slots and openings that are aligned in a straight line from a first side of the beam to a second side of the beam.

One example is directed to mount to connect a fan cowl support beam to a fan case. The mount comprises a primary load path component comprising a plurality of spacers each with an elongated shape and having a first end configured to be connected to the fan case and a second end configured to be connected to the fan cowl support beam. A secondary load path component comprises a flexible body component comprising a first end configured to be connected to the fan case and a second end configured to be connected to the fan cowl support beam. The primary load path component is configured to fuse upon application of a force from the fan case that is above a predetermined threshold. The secondary load path component is configured to remain functional upon application of the force above the predetermined threshold.

In another example, the secondary load path component comprises an interior space positioned between the first end and the second end with the first end of the plurality of spacers mounted to the first end of the secondary load path component and the second end of the plurality of spacers mounted to the second end of the secondary load path component.

One example is directed to a mount to movably connect a first member to a second member with the first member configured to move relative to the second member. The mount comprises a primary load path component connected to each of the first member and the second member with the primary load path component configured to connect the first member to the second member when a force applied by the first member is below a predetermined threshold. A second load path component is connected to each of the first member and the second member with the secondary load path component configured to connect the first member to the second member both when the force is above and below the predetermined threshold.

One example is directed to a method of mounting a fan cowl support beam to a fan case. The method comprises: supporting the fan cowl support beam relative to the fan case with both a primary load path component and a secondary load path component; applying an excessive force from the fan case to both the primary load path component and the secondary load path component; fracturing the primary load path component and flexing the secondary load path component while applying the excessive force; and supporting the fan cowl support beam relative to the fan case with just the secondary load path component after fracturing the primary load path component.

In another example, the method further comprises transferring forces from the fan case to the fan cowl support beam through the primary load path component prior to applying the excessive force.

In another example, the method further comprises transferring forces from the fan case to the fan cowl support beam through the secondary load path component prior to applying the excessive force.

In another example, the method further comprises applying the excessive force and shearing the primary load path component.

In another example, the method further comprises fracturing the primary load path component at a fusing feature.

In another example, the method further comprises applying the excessive force and crushing multiple spacers.

In another example, the method further comprises bending the secondary load path component to a first angular position while applying the excessive force, and reducing an amount of force applied to the fan cowl support beam through the fan case and bending the secondary load path component a lesser amount to a second angular position.

One aspect is directed to a method of mounting a fan cowl support beam to a fan case. The method comprises: connecting a fan cowl support beam to the fan case with a mount with the mount comprising a primary load path component and a secondary load path component; during flight transferring loads through both the primary load path component and a secondary load path component; during the flight, applying an excessive load from the fan case to the mount; causing the primary load path component to fuse from the excessive load; and connecting the fan cowl support beam to the fan case with just the secondary load path component after the primary load path component fails.

In another example, the method further comprises applying the excessive load during a fan blade out event during the flight.

In another example, the method further comprises flexing the secondary load path component while connecting the fan cowl support beam to the fan case.

One example is directed to a method of mounting a first member to a second member. The method comprises: supporting the first member relative to the second member with both a primary load path component and a secondary load path component; applying an excessive force from the first member to both the primary load path component and the secondary load path component; fracturing the primary load path component and flexing the secondary load path component while applying the excessive force; and supporting the first member relative to the aircraft with just the secondary load path component after fracturing the primary load path component.

The features, functions and advantages that have been discussed in these examples can be achieved independently in various aspects or may be combined in yet other aspects, further details of which can be seen with reference to the following description and the drawings.

### BRIEF DESCRIPTION OF THE DRAWINGS

FIG. 1 is an isometric view of an aircraft that includes engines connected to the wings.

FIG. 2 is a schematic section view of an isolated aircraft engine that depicts a fan cowl support beam attached to a fan case of the engine.

FIG. 3 is an isometric view of a mount that connects a fan cowl support beam to a fan case.

FIG. 4 is a detailed isometric view of a mount that connects a fan cowl support beam to a fan case.

FIG. 5 is a detailed isometric view of a mount that connects a fan cowl support beam to a fan case.

FIG. 6 is a detailed isometric view of a mount that connects a fan cowl support beam to a fan case.

FIG. 7 is a detailed isometric view of a mount that connects a fan cowl support beam to a fan case.

FIG. 8 is a section view cut along line VIII-VIII of FIG. 7 of a primary load path component.

FIGS. 9A-9C are schematic diagrams of bent flanges of a secondary load path component at different angular positions depending upon the amount of applied load.

FIG. 10 is a schematic diagram of a mount with a single primary load path component and multiple secondary load path components.

FIG. 11 is a flowchart diagram of a method of mounting a fan cowl support beam to a fan case.

FIG. 12 is a schematic diagram of a mount that connects together a first member and a second member.

### DETAILED DESCRIPTION

The present application is directed to a mount that connects a first member to a second member. The mount includes one or more primary load path components that fuse (e.g., intentionally fail) upon application of an elevated force. The mount also includes one or more secondary load path components that maintain the connection between the first member and the second member after fusing of the one or more primary load path components. The mount is designed to be tuned for the one or more primary load path components to fuse when exposed above a specific load. The one or more secondary load path components are designed to deflect and have the required strength to maintain the connection of the members during the fusing of the one or more primary load path components.

The mount will be disclosed within the context of an aircraft in which the mount connects a fan cowl support beam to an engine fan case. However, the mount is applicable for use in other contexts in which two members are connected together.

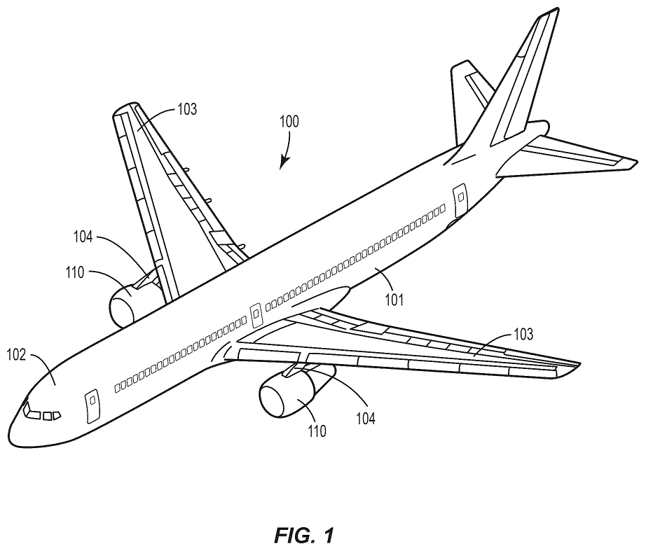

FIG. 1 illustrates an aircraft 100 configured to transport passengers and/or cargo. The aircraft 100 generally includes a fuselage 101 with an interior space configured to accommodate the passengers and/or cargo. The interior space of the fuselage 101 also includes a flight deck 102 with various controls to enable flight personnel to control the aircraft 100. Engines 110 are mounted to the wings 103 on opposing sides of the fuselage 101. The engines 110 are mounted under the wings 103 to strut boxes 104.

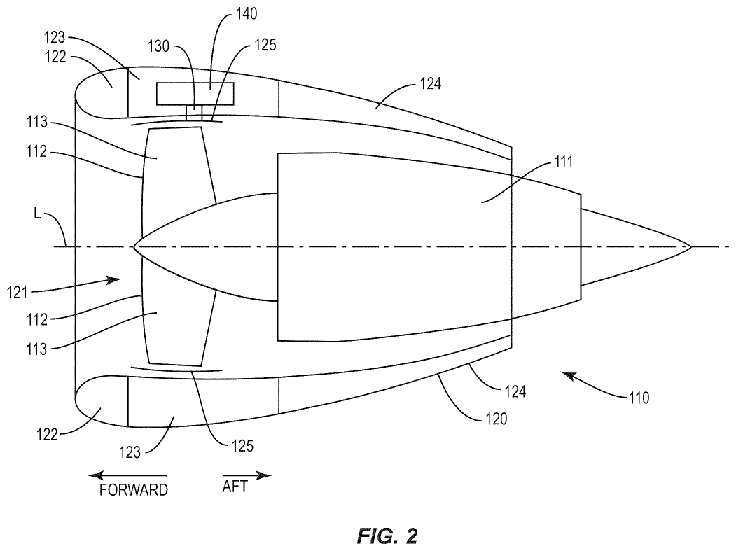

FIG. 2 schematically illustrates a sectional view of the engine 110. The engine 110 includes an engine core 111 that is mounted to the wing and a nacelle 120. The engine core 111 can include a variety of different configurations, including but not limited to a gas turbine engine. The engine 110 includes a fan 112 with blades 113 to draw air into the engine core 111. A fan case 125 is mounted to the engine core 111 and positioned radially outward from the fan 112. The nacelle 120 extends around and protects the engine core 111 and fan 112. The nacelle 120 includes a generally cylindrical shape with an inlet 121 through which air is drawn into the fan 112 and engine core 111. The nacelle 120 is divided into multiple different sections along its length. An inlet cowl 122 is positioned at a forward end of the nacelle 120. A fan cowl 123 is positioned aft of the inlet cowl 122 and is aligned to extend around the fan 112. The nacelle 120 also includes a thrust reverser cowl 124 aft of the fan cowl 123. One or more mounts 130 connect the fan cowl support beam 140 to the fan case 125.

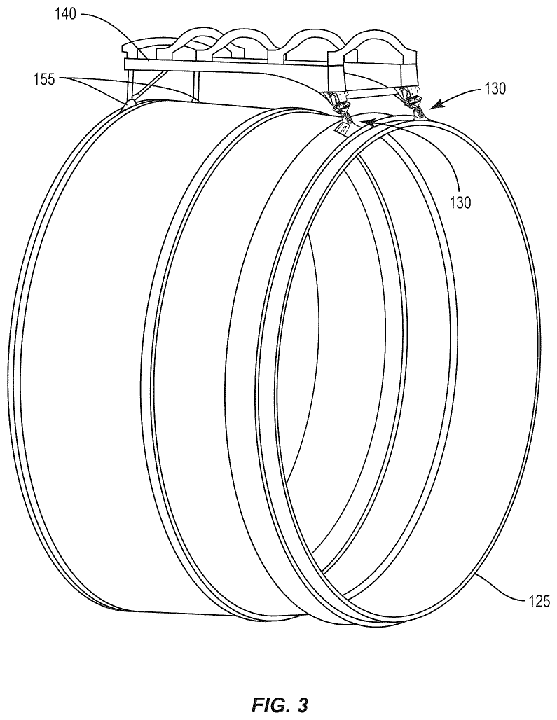

FIG. 3 illustrates mounts 130 that connect the fan cowl support beam 140 to the fan case 125. One or more additional mounts 155, such as forward mounts, further connect the fan cowl support beam 140 to the fan case 125. During an FBO event, one or more of the blades 113 break off from the fan 112. This can include an entire blade or a section of the blade. A large initial force is exerted on the fan case 125 due to this contact. Further, a large force/deflection wave is generated that travels around the fan case 125 as the now unbalanced fan 112 continues to spin during engine rundown. Further, after run down, the engine 110 will continue to windmill for the remainder of the flight in which the FBO event has occurred which will produce a high number of low load cycles due to the imbalanced load.

The mounts 130 are designed to withstand the forces applied during the FBO event and maintain the fan cowl support beam 140 connected to the fan case 125. The mount 130 includes a primary load path and a secondary load path. The primary load path is designed to fuse during the FBO event. In some examples, the fusing initially includes buckling and/or fracturing which absorbs energy and helps to protect the fan cowl support beam 140. The primary load path is designed to fuse when a predetermined force is applied. In some examples, the predetermined force is higher than an expected highest load that is expected to be experienced during normal flight operations.

The secondary load path remains attached to maintain the connection between the fan case 125 and the fan cowl support beam 140. In some examples, the secondary load path has a spring configuration to flex to absorb the energy applied by the engine 110 and help to protect the fan cowl support beam 140. The secondary load path is designed to deflect to enable the fusing of the primary load path yet maintain the structural connection. The secondary load path remains connected to prevent an unexpected departure of the fan cowl 123 or other components from the aircraft 100.

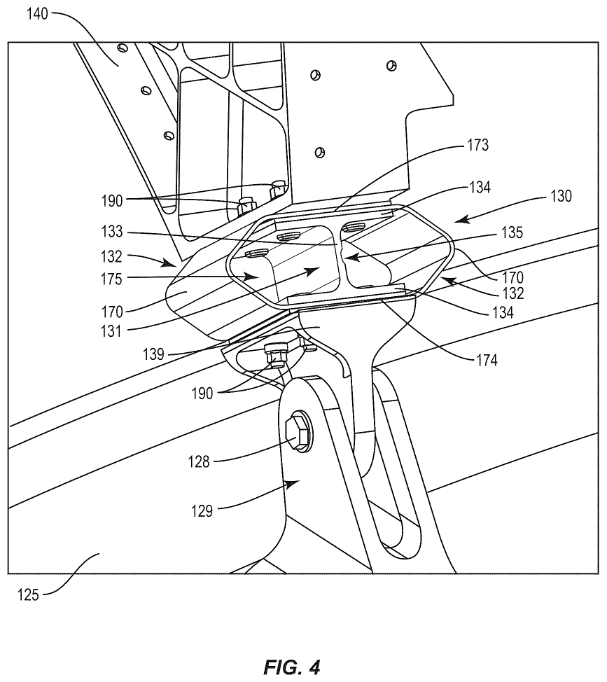

FIG. 4 illustrates a mount 130 that connects a fan cowl support beam 140 to a fan case 125. The mount 130 includes one or more primary load path components 131 and one or more secondary load path components 132. The mount 130 is configured to connect either directly or indirectly to the fan cowl support beam 140 and the fan case 125. In this example, the mount 130 is connected with fasteners 190 directly to the fan cowl support beam 140. The mount 130 is indirectly connected to the fan case 125 through an intermediate fitting 139 that is mounted to a fitting 129 on the fan case 125. A fastener 128 pivotally connects the intermediate fitting 139 to the fan case fitting 129.

In some examples as illustrated in FIG. 4, the fitting 139 is a separate component that is connected to the mount 130 through fasteners 190. In other examples, the fitting 139 is integrally formed with the mount as a one-piece unitary member.

The one or more primary load path components 131 structurally connect the fan cowl support beam 140 to the fan case 125. The structural integrity of the one or more primary load path components 131 is designed to maintain integrity below a predetermined threshold. The primary load path components 131 can include various shapes and sizes. FIG. 4 includes an example with a single primary load path component 131 having a substantially I-shape with a central beam 133 that extends between flanges 134. The primary load path component 131 is configured to fuse upon application of a force above the predetermined threshold. The primary load path component 131 includes one or more fusing features 135 that are designed to fuse prior to fusing of the remaining structure. In the example of FIG. 4, the fusing feature 135 includes an indent that extends the length and has a reduced sectional size. In this specific example, the indent has a narrower thickness than a remainder of the beam 133. The fusing feature 135 is configured to fuse while the other sections of the primary load path component 131 remain structurally viable. The fusing feature 135 can be tuned as needed to fuse at a desired predetermined threshold. By way of example, a deeper indent with a narrower thickness has a lower predetermined threshold than a shallower indent with a larger thickness.

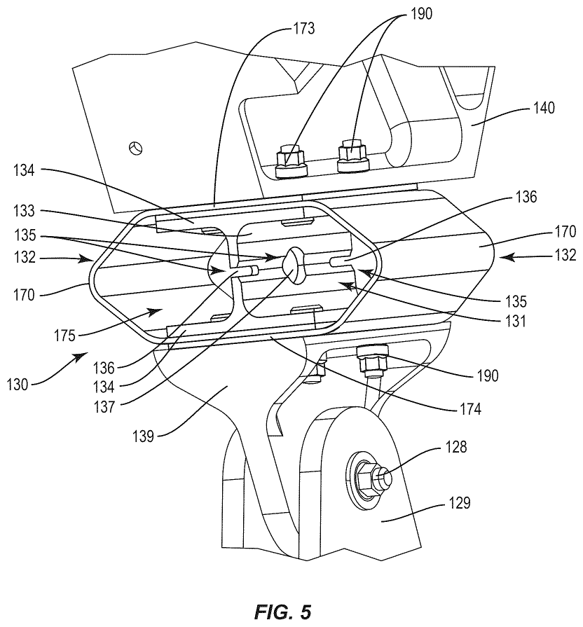

FIG. 5 includes an example of a primary load component 131 with multiple fusing features 135. A first fusing feature 135 includes slots 136 that extend inward from the outer edges of the beam 133. A second fusing feature 135 includes an opening 137 positioned in the beam 133. In some examples, another fusing feature includes the section of the beam 133 that extends between the slots 136 and opening 137 having a narrower thickness than a remainder of the beam 133. In the example of FIG. 5, the different fusing features 135 are aligned in a straight line along the length of the beam 133. This positioning provides for the beam 133 to fuse along this line.

The fusing features 135 can be tuned to adjust the force at which the primary load path component 131 fuses. Examples of tuning the fusing features 135 of FIG. 5 include but are not limited to changing the length of one or both slots 136, changing the size of the opening 137. In examples that include multiple fusing features 135, the tuning can include tuning a single fusing feature 135 or tuning two or more of the fusing features 135.

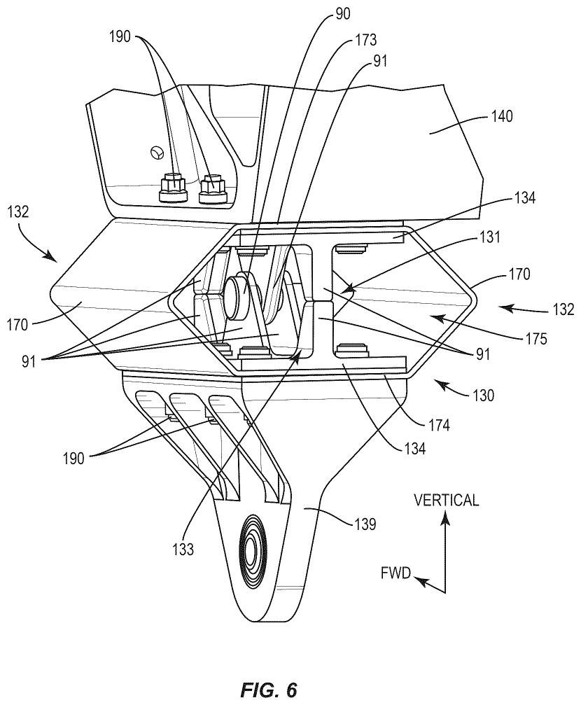

FIG. 6 illustrates an example with the primary load component 131 that substantially forms a beam 133. The beam 133 includes upper and lower flanges 134 and extensions 91 that extend outward from the flanges 134. Extensions 91 at the front and back abut together to form posts. Intermediate extensions 91 overlap and are connected together by a fuse pin 90. In some examples, the extensions 91 and fuse pin 90 form a clevis joint. During normal operation, the beam 133 react loads in the fore/aft and vertical directions and about the pitch moment axis. During an FBO event, the force causes the fuse pin 90 and thus the beam 133 to fuse thus causing the flanges 170 to start reacting the loads. The flanges 170 function in the same manner as examples of FIGS. 4 and 5.

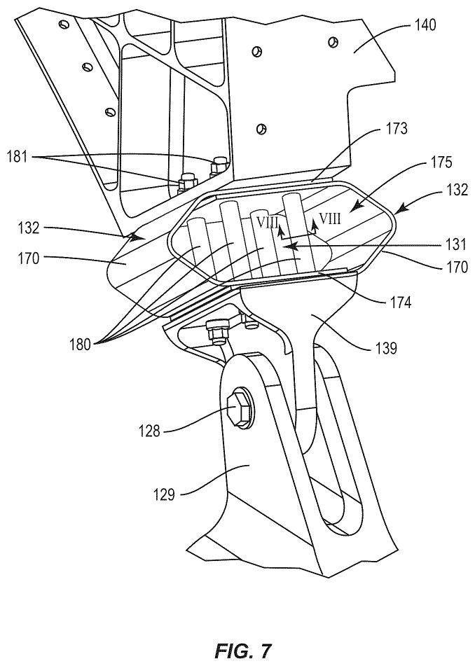

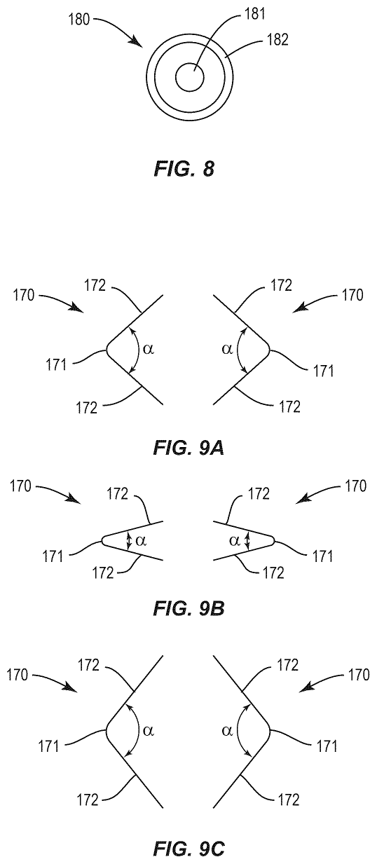

FIG. 7 illustrates an example with multiple primary load path components 131 that include spacers 180. The spacers 180 include an elongated shape and are positioned between within an interior space 175 of the secondary load path component 132. In some examples, the spacers 180 are connected to the fan cowl support beam 140 and the intermediate fitting 139. In some examples as illustrated in FIGS. 7 and 8, the spacers 180 include a bolt 181 and a sleeve 182. The bolt 181 includes a head that is positioned at one of the fan cowl support beam 140 and intermediate fitting 139, and an opposing threaded end configured to receive a nut. The sleeve 182 extends around the bolt 181. The sleeve 182 is constructed to crush/crumple during an FBO event.

The number, positioning, and shape/size of the one or more primary load path components 131 can vary. In some examples, each of the multiple primary load path components 131 are identical. In other examples, two or more of the primary load path components 131 have different shapes and/or sizes and/or constructions. In one example, the primary load path components 131 include an I-beam as illustrated in FIG. 4 or 5, and one or more crushable spacers 180 as illustrated in FIG. 7.

Fusing of the one or more primary load path components 131 causes the one or more secondary load path components 132 to maintain the connection between the fan case 125 and the fan cowl support beam 140. The one or more secondary load path components 132 are able to withstand forces above the predetermined threshold at which the primary load path component 131 fuses. In some examples, the secondary load path component 132 is configured to flex and absorb the applied loads. This enables the secondary load path component 132 to absorb the forces applied by the unbalanced fan 112 as it continues to spin during the FBO event.

FIGS. 4, 5, 6, and 7 illustrate a secondary load path component 132 that includes a top section 173, a bottom section 174, and a pair of intermediate flanges 170 that are bent. An intermediate space 175 is formed between the top section 173 and the bottom section 174 and is sized to position the one or more primary load path components 131. The secondary load path component 132 is constructed from a single elongated material. The top section 173 and the bottom section 174 include a two-ply construction with the flanges 170 having a single-ply construction.

In the examples of FIGS. 4, 5, 6, and 7, the flanges 170 include a folded overlapping configuration. The configuration enables the flanges 170 to flex and deform as the different forces are applied. This movement absorbs some of the force that is being applied by the fan case 125. FIGS. 9A-9C schematically illustrate the flanges 170 flexing during application of different forces. Each of the flanges 170 includes an overlapping configuration with a pair of arms 172 connected at an elbow 171. FIG. 9A illustrates the flanges 170 at a first orientation, such as during application of a first force. The arms 172 are aligned at an angle α. FIG. 9B illustrates the flanges 170 during application of a second force. This compressive force causes the arms 172 to fold inward in closer proximity with the angle α having been reduced. FIG. 9C illustrates the flanges 170 during application a third force. This tension force causes the arms 172 to extend outward with the angle α having been increased. The extent of movement and positioning of the flanges 170 varies depending upon the applied force.

In some examples, the secondary load path component 132 does not change shape prior to fusing of the primary load path component 131. In other examples, the secondary load path component 132 changes shape when the primary load path component remains viable.

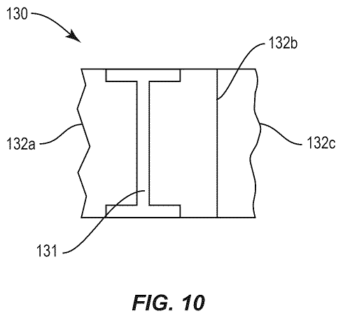

In some examples as illustrated in FIGS. 4-7, the mount 130 includes a single secondary load path component 132. In other examples, the mount includes multiple secondary load path component 132. The different secondary load path component 132 can include the same or different shape and/or construction and/or size. FIG. 10 schematically illustrates an example of a mount 130 with multiple secondary load path components 132. In this example, each of the secondary load path components 132 has a different shape and construction.

In some examples, the one or more primary load path components 131 and secondary load path components 132 are separate members. In the examples of FIGS. 4 and 5, the primary load path component 131 comprises a substantially I-shaped member that includes the beam 133 and flanges 134. The secondary load path component 132 includes flanges 170 and flanges 173. The flanges 173 of the secondary load path component 132 are connected to the flanges 34 of the primary load path component 131. In other examples, the primary load path component 131 and the secondary load path component 132 are an integral one-piece member.

In some examples as described above, the one or more secondary load path components 132 are configured to flex to changes shapes and/or sizes due to the applied forces. In some examples, the secondary load path components 132 are designed to remain static and maintain the same shape/size during application of the various forces.

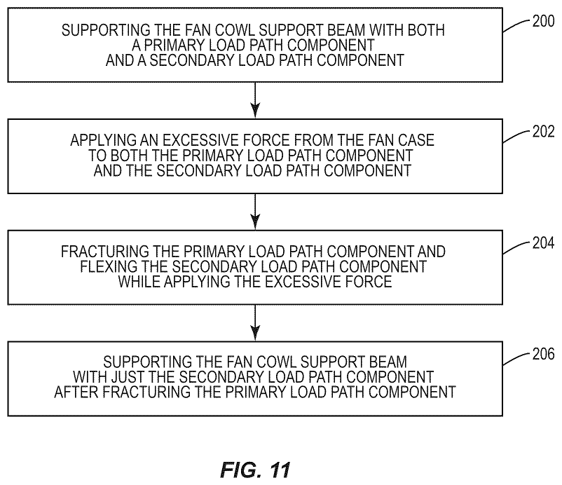

FIG. 11 illustrates a method of mounting a fan cowl support beam 140 to a fan case 125. The method includes supporting the fan case 125 relative to the fan cowl support beam 140 with both a primary load path component 131 and a secondary load path component 132 (block 200). During use, the fan case 125 applies an excessive force to both the primary load path component 131 and the secondary load path component 132 (block 202). The method includes fusing the primary load path component 131 and flexing the secondary load path component 132 (block 204). The method also includes supporting the fan case 125 relative to the fan cowl support beam 140 with just the secondary load path component 132 after fusing the primary load path component 131 (block 206).

One application for the mount is as a mount 130 for use with an aircraft 100 as described above. Other applications include but are not limited to dynamic types of events that have high loads cycling for a short period of time which can occur at different locations on the aircraft 100. Other applications include other contexts on the aircraft 100.

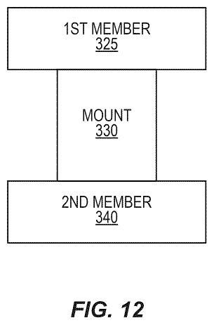

The mount can also be used in a variety of other contexts to connect together first and second members. FIG. 12 schematically illustrates an example with the mount 330 connecting together a first member 325 and a second member 340. The mount 330 includes one or more primary load path components and one or more secondary load path components. The mount 330 is configured to absorb a high force applied by the first member 325 causing the one or more primary load path components to fuse. The one or more secondary load path components remain operational and structurally connect together the first member 325 and the second member 340.

By the term “substantially” with reference to amounts or measurement values, it is meant that the recited characteristic, parameter, or value need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A mount to connect a fan cowl support beam to a fan case of an aircraft, the mount comprising:
a primary load path component configured to be connected to the fan cowl support beam and to the fan case;
a secondary load path component comprising a flexible body comprising a first end configured to be connected to the fan cowl support beam and a second end configured to be connected to the fan case;
wherein the primary load path component is configured to fuse upon application of a force from the fan case that is above a predetermined threshold; and
wherein the secondary load path component is configured to remain functional upon application of the force above the predetermined threshold to maintain the fan cowl support beam 140 connected to the fan case.

2. The mount of claim 1, wherein the secondary load path component comprises an interior space formed between the first end and the second end and the primary load path component is positioned within the interior space.

3. The mount of claim 1, wherein the primary load path component comprises a beam comprising an elongated shape with a first end connected to the first end of the secondary load path component and a second end mounted connected to the second end of the secondary load path component.

4. The mount of claim 3, further comprising a fusing feature positioned along the beam between the first end and the second end of the beam, the fusing feature comprising a smaller sectional size than a remainder of the beam.

5. The mount of claim 1, wherein the primary load path component comprises spacers that extend between the first end and the second end of the secondary load path component, the spacers being spaced apart within an interior space of the secondary load path component.

6. The mount of claim 1, wherein the primary load path component comprises:
a support section; and
a fusing feature configured to fuse prior to the support section when the force applied by the fan case is above the predetermined threshold.

7. The mount of claim 1, wherein the primary load path component comprises a beam with upper and lower flanges and extensions that extend outward from the flanges, the primary load component further comprising a fuse pin that connects together two or more of the extensions.

8. The mount of claim 1, wherein the primary load path component and the secondary load path component are separate members that are connected together.

9. The mount of claim 1, wherein the secondary load path component comprises a pair of bent flanges that comprise arms that are connected together at an elbow with the arms configured to move relative to each other and be positioned at different angular positions.

10. A mount to connect a fan cowl support beam to a fan case of an aircraft, the mount comprising:
a primary load path component comprising:
a beam comprising an elongated shape with a first end configured to be connected to the fan cowl support beam and a second end configured to be connected to the fan case;
a fusing feature positioned along the beam between the first end and the second end, the fusing feature comprising a smaller sectional size than a remainder of the beam;
a secondary load path component comprising:
a flexible body comprising a first end configured to be connected to the fan cowl support beam and a second end configured to be connected to the fan case;
wherein the primary load path component is configured to fuse upon application of a force from an engine that is above a predetermined threshold; and
wherein the secondary load path component is configured to remain functional upon application of the force above the predetermined threshold.

11. The mount of claim 10, wherein the primary load path component is mounted within an interior space of the flexible body of the secondary load path component.

12. The mount of claim 10, wherein the secondary load path component comprises a plurality of flexible bent flanges with the primary load path component positioned between two of the plurality of flexible bent flanges.

13. The mount of claim 10, wherein the fusing feature comprises a thickness that is less than a remainder of the beam.

14. The mount of claim 13, wherein the primary load path component comprises a beam with extensions that extend outward from opposing flanges, and wherein the fusing feature comprises a fuse pin that connects together a plurality of the extensions.

15. The mount of claim 10 wherein the primary load path component comprises a plurality of spacers each with an elongated shape and having a first end configured to be connected to the fan cowl support beam and a second end configured to be connected to the fan case.

16. A method of mounting a fan cowl support beam to a fan case of an aircraft, the method comprising:
supporting the fan cowl support beam on the fan case during flight with both a primary load path component and a secondary load path component;
during the flight, applying an excessive force from the fan case to both the primary load path component and the secondary load path component;
fusing the primary load path component and flexing the secondary load path component while applying the excessive force; and
supporting the fan cowl support beam relative to the fan case with just the secondary load path component after fusing the primary load path component.

17. The method of claim 16, further comprising transferring forces on the fan case to the fan cowl support beam through the primary load path component and the secondary load path component prior to applying the excessive force.

18. The method of claim 16, further comprising fusing the primary load path component at a fusing feature.

19. The method of claim 16, further comprising:
bending the secondary load path component to a first angular position while applying the excessive force; and
reducing an amount of force applied to the fan cowl support beam through the fan case and bending the secondary load path component a lesser amount to a second angular position.

20. The method of claim 16, further comprising applying the excessive load during a fan blade out event during the flight.
